(19) United States
(12) Patent Application Publication
(10) Pub. No.: US 2019/0126656 A1
(43) Pub. Date: May 2, 2019

(54) PRINT AGENT DRYING

(71) Applicant: HP SCITEX LTD., Netanya (IL)

(72) Inventors: Alex Veis, Kadima (IL); Eyal Kotik, Netanya (IL)

(73) Assignee: HP SCITEX LTD., Netanya (IL)

(21) Appl. No.: 16/034,582

(22) Filed: Jul. 13, 2018

(30) Foreign Application Priority Data
Oct. 30, 2017 (EP) 17199240.7

(51) Int. Cl. B41M 5/00

(52) U.S. Cl. CPC B41M 5/0017

(57) ABSTRACT

There is disclosed print agent drying unit 10, 20, 30 to dry print agent 40 on a substrate 14, the drying unit comprising: a substrate support 12 to support a substrate 14; an exciter 18, 28, 38 to excite a boundary layer of print agent 40 applied on the substrate 14, to thereby dissociate the boundary layer from the print agent; and a radiation source 16 to direct radiation energy to the substrate to dry the print agent. Methods of drying print agent 40 on a substrate 14 are also disclosed, including a method comprising: causing the substrate 14 to vibrate to dissociate a boundary layer of print agent 40 on the substrate 14; and heating the print agent 40 to dry the print agent 40.

### BACKGROUND

The disclosure relates to print agent drying.

In liquid printing operations, liquid print agents such as inks, fixers, primers and coatings may be applied to a substrate. A substrate carrying such a print agent may be dried, for example by heating using hot air convection.

### BRIEF DESCRIPTION OF DRAWINGS

Examples will now be described, by way of non-limiting example, with reference to the accompanying drawings, in which:

FIG. 1 is a simplified schematic of an example print agent drying unit

FIG. 2 is a simplified schematic of a further example print agent drying unit;

FIGS. 3 to 6 are simplified schematics of a further example print agent drying unit at stages of a drying operation;

FIG. 7 is a simplified schematic of a further example print agent drying unit at a stage of a drying operation; and

FIGS. 8 to 10 are flowcharts of examples methods of print agent drying.

### DETAILED DESCRIPTION

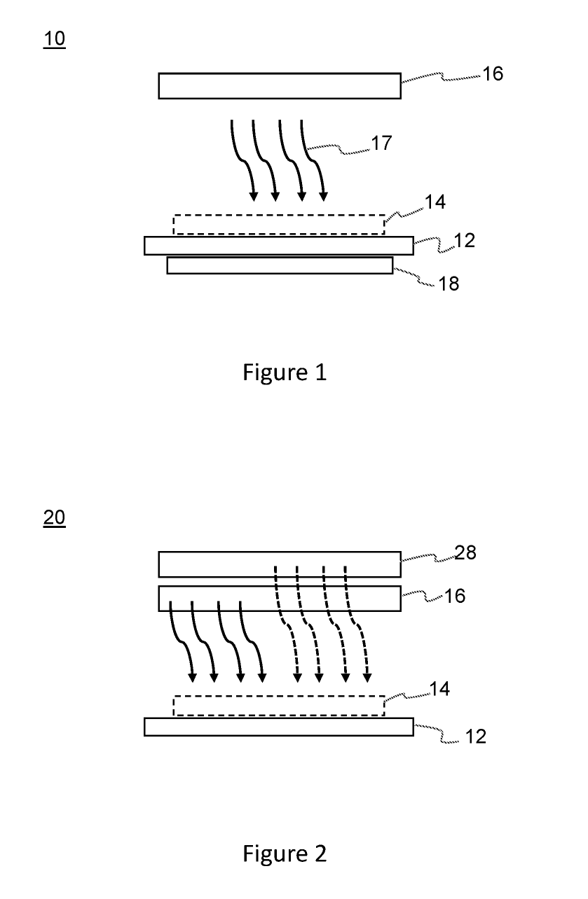

FIG. 1 schematically shows an example print agent drying unit 10 in cross-sectional side view. The print agent drying unit 10 comprises a substrate support 12 which may comprise a substantially planar support bed. In other examples, a substrate support may take other forms, for example it may comprise a print roller for conveying a substrate.

The substrate support 10 is to support a substrate 14, which is shown in dashed lines in FIG. 1. The substrate support 10 may receive the substrate 14 from a conveyor, such as a conveying roller or belt. For example, the substrate support 10 may receive the substrate 14 from a print agent application unit of a print apparatus.

The substrate 14 may carry a print agent applied on it. For example, the print agent may be an ink, fixer, primer or coating. The print agent may comprise solvents and a functional solute, such as a colorant (e.g. a pigment or dye), examples of which will be described below. The solute may be dissolved or held in suspension.

The print agent drying unit 10 further comprises a radiation heater to direct radiation energy to print agent on the substrate 14. For example, the radiation heater may be to direct infrared light or ultraviolet light to print agent on the substrate. A wavelength of the radiation energy may be selected for heating a component of the print agent, for example for heating a functional solute of a print agent as disclosed in US 2017/028707.

The print agent drying unit 10 further comprises an exciter 18 to excite a boundary layer of print agent applied on the substrate, to thereby dissociate the boundary layer from the print agent, as will be described in detail below.

The exciter 18 may be to cause the substrate to vibrate so as to excite the boundary layer. The exciter 18 may be integral with or coupled to the substrate support 12 to cause the substrate support to vibrate, as is shown by way of example in FIG. 1.

FIG. 2 shows a further example of a print agent drying unit 20 which differs from the print agent drying unit 10 described above with respect to FIG. 1 in that the exciter 28 may be from the substrate support 12, and may be to direct acoustic waves towards the substrate support 12, and thereby towards print agent applied on any substrate 14 received on the substrate support 12, to dissociate a boundary layer from the print agent.

In some examples, the print agent drying unit may be for drying print agent used in a high speed printing operation, such as high speed digital press printing. In such operations, print agents may pass through a small diameter nozzle, such as a 10 micron nozzle.

A composition selected for a print agent may depend on a nozzle diameter through which it is to pass. For example, print agents for smaller nozzle diameters may have a relatively higher proportion of a solvent (such as water), with a relatively lower proportion of a functional solute (such as a colorant), as compared with print agents for larger nozzle diameters. This may inhibit drying within the nozzle.

Print agent compositions may comprise a solvent selected to avoid drying during application (i.e. within the nozzle). Particularly in high speed printing operations with small nozzle diameters, a print agent may comprise a second solvent which is slow -drying or non-volatile, in addition to a first solvent (such as water). Such second solvents are selected for their resistance to drying during application (i.e. in the nozzle), which resistance may persist when applied to a substrate. Example second solvents include glycerol and DPG (dipropylene glycol). The second solvent may have a higher molecular weight than the first solvent. In examples, the first solvent may be water, and the second solvent may have a higher molecular weight than water. The second solvent may have a higher saturation temperature (boiling temperature or boiling point) than the first solvent. In examples, the first solvent may be water, and the second solvent may have a higher saturation temperature than water.

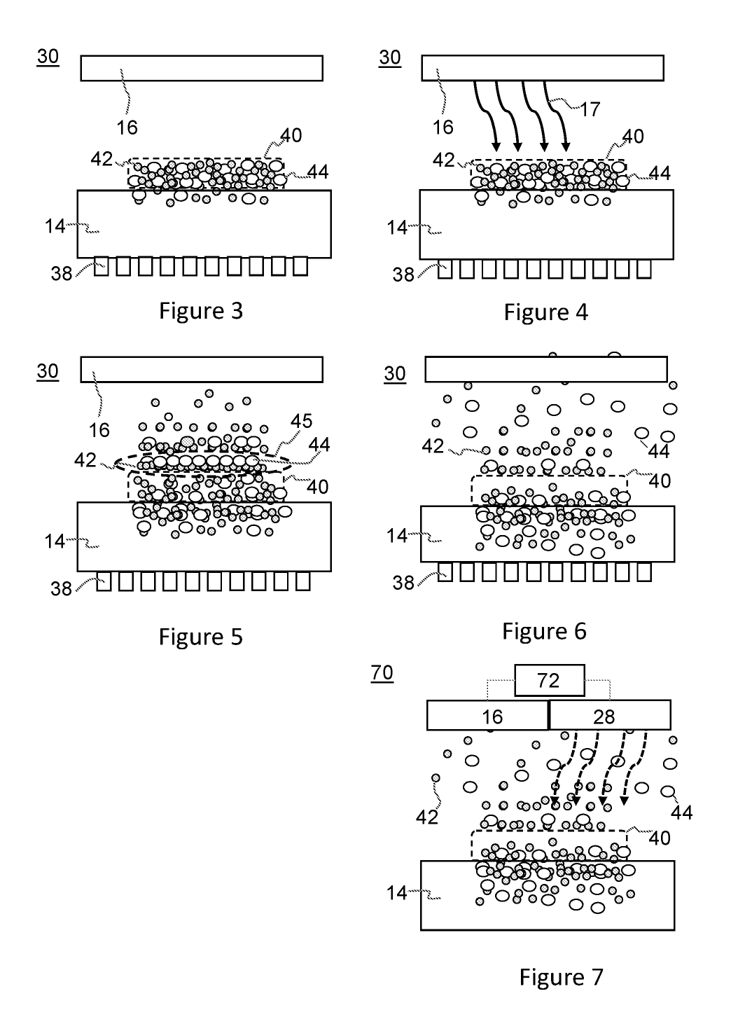

The print agent drying units and methods disclosed herein may dry print agents comprising such second solvents, as will now be further described with reference to an example method of drying print agent, various stages of which are illustrated in FIGS. 3-6.

FIG. 3 schematically shows a substrate 14 received in a third example print agent drying unit 30, which differs from the print agent drying unit 10 described above with respect to FIG. 1 in that the exciter 38 comprises a plurality of suction passageways for coupling to a vacuum source for retaining the substrate 14 against the exciter 38. In this example, the exciter 38 comprises the substrate support, such that the exciter 38 supports the substrate in use. The exciter 38 may be coupled to a support frame. In this example, the exciter 38 is to contact the substrate 14 for directly vibrating the substrate. In this particular example, the exciter 38 comprises an array of piezoelectric transducers to cause vibration of the substrate. In other examples, other transducers may be used, for example moving coil transducers. In use, the substrate 14 is retained on the exciter 38 by a pressure differential acting on the substrate owing to the suction passageways of the exciter being coupled to a vacuum or low pressure source.

As shown, the substrate 14 carries a deposit of print agent 40, for example as applied onto the substrate by a print apparatus from which the substrate 14 may be received. In this example, the print agent 40 comprises a first solvent 42 (such as water), a second solvent 44 (such as glycerol), and a functional solute 46, which in this example is a colorant (for example, a pigment or dye). The second solvent may have anti-drying properties, or may be non-volatile. Such second solvents may be of higher molecular weight than first solvents for carrying a functional solute, such as water. In this example the substrate 14 is a paper, although any other suitable substrate can be used, for example cardboard. The substrate may be a porous substrate.

FIG. 3 shows the substrate 14 shortly after it is received from a print apparatus, at which point there is minor absorption of first and second solvent molecules 42, 44 into the substrate 14 from the print agent 40, whilst the functional solute remains on the surface of the substrate 14.

In this example, the print agent drying unit 30 further comprises a controller to control the exciter 38 and optionally the heater 16, as will be described below. Other examples print agent drying units as described herein may also comprise such a controller.

FIG. 4 shows heating of the print agent 40 with radiation energy 17 from the radiation heater 16. In this example, the radiation heater 16 is to emit ultraviolet radiation, the wavelength of which may be selected to correspond to the functional solute, for energy efficient (and thereby rapid) heat transfer and drying. For example, the wavelength may be selected, from a range of wavelengths, to correspond to optimum heat transfer to the selected functional solute 46, so that in use the solute may be heated by radiation, and heat may be transferred from the solute to the first and second solvents for drying. In other examples, any type of heater may be used, such as a forced flow or convection heater (i.e. a blower).

As the print agent 40 is heated, molecules of first and second solvent migrate towards the surface of the deposit of print agent 40, where there is partial vaporisation of the first solvent 42 and second solvent 44. The partial vaporisation results in some vapour of both solvents 44 ,42 departing from the surface of the deposit of print agent, and some vapour of both solvents remaining at the surface of deposit of print agent 40 where they form a vapour saturated boundary layer, as shown in FIG. 5. The vapour saturated boundary layer 44 may inhibit further vaporisation of the solvents (i.e. which may inhibit further drying of the print agent 40). In particular, vapour of the higher molecular weight second solvent may prevent vaporisation and diffusion of the lower molecular weight first solvent from the surface of the deposit of print agent.

The exciter 38 is activated to cause the substrate 14 to vibrate. In this example, the controller 32 controls the exciter 38 to vibrate at a frequency of approximately 50 MHz, and at an amplitude of approximately 50 microns in a direction normal to the plane of the exciter (i.e. normal to the plane of the substrate received on the exciter 38), to cause corresponding vibration of the substrate 14. In other examples, the frequency and amplitude may be greater or less, for example the frequency may be between approximately 100 Hz and 100 MHz, and the amplitude may be between 10 microns and 200 microns.

The vibration of the substrate causes vapour of higher molecular weight second solvent 44 at the vapour saturated boundary layer of the print agent 40 to dissociate from the print agent 40, as shown in FIG. 6 References herein to dissociation of the boundary layer refer to the separation of vapour of either or both the first solvent and the second solvent at the boundary layer from the deposited print agent 40, such that they depart the surface of the deposit of print agent (i.e. in other words they are ejected from the vapour saturated boundary layer and thereby from the surface of the deposit of print agent).

The vibration characteristics (i.e. amplitude, frequency) may be selected to cause vapour of the higher molecular weight second solvent (and optionally vapour of the lower molecular weight first solvent) at the boundary layer to dissociate from the print agent, whilst preventing dissociation of the solvents in liquid phase and of the functional solute (i.e. the colorant in this example), such that they remain on the substrate. The liquid molecules may resist dissociation (i.e. ejection) from the substrate owing to surface energy and capillary forces. Accordingly, the boundary layer may be dissociated without promoting de-watering (i.e. ejection of liquid molecules) of the print agent or substrate, which may otherwise cause the functional solute to be ejected from the substrate. The applicant has found that suitable vibration characteristics may be identified for particular print agent and substrate combinations by experimentation.

Example print agents may include functional solutes, such as a pigment. Example print agents may include binders that bind the functional solute particles to the substrate. Example print agents may include dispersants that disperse relatively small solute particles during printing. Such print agents may be printed onto a substrate to which a bonding agent (or fixer) has been applied. The bonding agent may counteract the dispersant so that the relatively small solute particles are attracted to each other to form the relatively large combined solute particles. The combined solute particles may be significantly larger than the molecules of vaporised first and second solvents in the vapour -saturated boundary layer. This may inhibit dissociation or ejection of the solute particles during excitation of the boundary layer.

Dissociation of at least the vaporised higher molecular weight second solvent at the boundary layer from the print agent enables continued migration of lower molecular weight first solvent to the surface of the print agent for vaporisation. Accordingly, dissociation of the higher molecular weight second solvent permits continued drying of the print agent.

Whilst FIGS. 3-6 relate to an example in which the exciter directly vibrates the substrate, it will be appreciated that in other examples a vibrating exciter may be coupled to a substrate support to indirectly vibrate the substrate.

In this example, heating is done by directing radiation energy to the substrate, and the substrate is subsequently vibrated to cause dissociation of the boundary layer. In other examples, heating and vibration may occur simultaneously or in repeating alternating sequence.

FIG. 7 shows yet a further example in which the boundary layer is dissociated form print agent 40 by excitation using an exciter 28 of a print agent drying unit 70 which is separate from a substrate support. In this particular example, the exciter 28 is disposed over and opposing a substrate 14 on which print agent is received (i.e. opposite the substrate support), at approximately the same level as a radiation heater 16. The exciter is to direct acoustic waves towards the substrate 14 to cause alternating sequence of high pressure and low pressure at the surface of the print agent, to thereby energize the higher molecular weight second solvent and cause dissociation of vaporised second solvent from the print agent, as shown. As described above with respect to the exciter 38 of FIGS. 3-6, frequency and amplitude characteristics of the exciter 28 may be selected from a range. For example a controller 72 of the print agent drying unit 70 may control the exciter 28 to emit acoustic waves at a frequency in a frequency range of approximately 1 kHz to 200 kHz and at an amplitude in an amplitude range of approximately 1 micron to 200 microns for acoustic excitation.

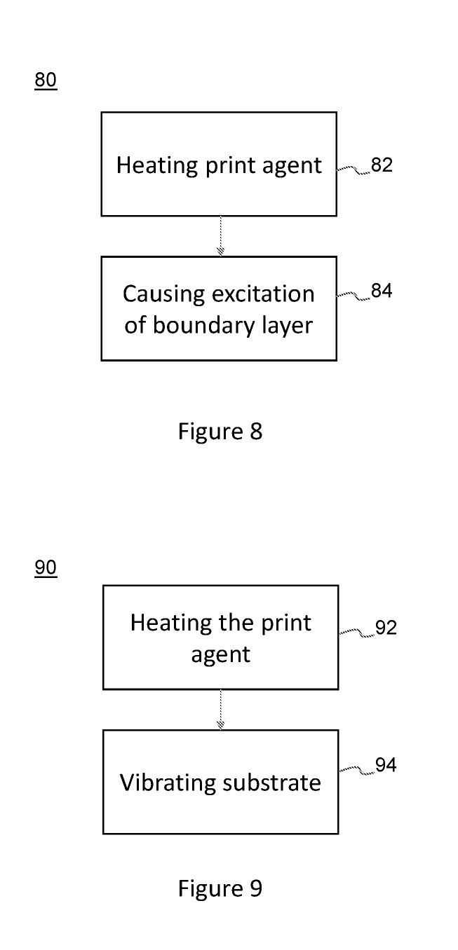

FIG. 8 is a flowchart of a method 80 of drying print agent. In block 82, the print agent is heated using radiation energy from a radiating heater, to thereby dry the print agent. For example, the heater may be an ultraviolet heater as described above with respect to the example print agent drying unit 20.

In block 84, excitation of a boundary layer of print agent deposited on a substrate is caused, to thereby dissociate the boundary layer from the print agent. For example, the excitation may be caused by activation of an exciter separate from any substrate support, to direct acoustic waves towards the substrate, as in the print agent drying units 20, 70 of FIGS. 2 and 7 respectively.

The excitation and heating may occur sequentially or simultaneously. Continued heating after excitation may promote continued vaporisation of solvent after dissociation of a boundary layer of print agent. In this particular example, heating and excitation occur simultaneously. However, in other examples, there may be initial heating of print agent, followed by excitation, followed by further heating. Heating and excitation may alternate repeated times for a respective portion of print agent.

FIG. 9 is a flowchart of a further example method 90 of drying print agent. In block 92, the print agent is heated to cause drying of the print agent. In this example, the heater is a forced flow heater (i.e. a convection heater) to direct a flow of heated gas, such as air, over the print agent.

In block 94, excitation of a boundary layer of print agent deposited on a substrate is caused, to thereby dissociate the boundary layer from the print agent. In this example, the excitation is caused by vibrating the substrate, as in the print agent drying units 10, 30 of FIGS. 1 and 3-6 as described above. The substrate may be caused to vibrate at a frequency within a frequency range of between 100 Hz and 100 MHz. The substrate may be caused to vibrate at an amplitude within an amplitude range of between approximately 10 microns and 200 microns. In this example, the print agent comprises a lower molecular weight solvent, a higher molecular weight solvent, and a functional solute (e.g. a colorant) suspended or dissolved in the low molecular weight solvent. The substrate is caused to vibrate at vibration conditions selected to cause at least vaporised higher molecular weight solvent at the boundary layer to dissociate from the print agent, whilst liquid molecules of the solvents and the functional solute remain on the substrate.

The excitation and heating may occur sequentially or simultaneously. Continued heating after excitation may promote continued vaporisation of solvent after dissociation of a boundary layer of print agent. In this particular example, heating and excitation occur simultaneously. However, in other examples, there may be initial heating of print agent, followed by excitation, followed by further heating. Heating and excitation may alternate repeated times for a respective portion of print agent.

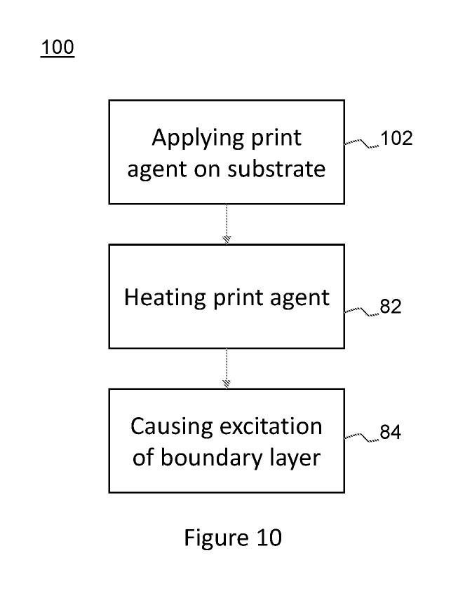

FIG. 10 is a flowchart of a method of printing and drying print agent. In block 102, print agent is printed on a substrate. In this particular example, the print agent is an ink comprising water as a first solvent, a second solvent such as glycerol, and a functional solute which may comprise particles of pigment. The print agent is applied at high speed through a nozzle having a small diameter, for example between 5 microns and 50 microns, for example 10 microns. Blocks 82 and 84 are as described above with respect to FIG. 8. The print agent may be applied in a high speed printing process. A high speed printing process may be one in which print agent is applied on a respective portion of a substrate in no more than one pass. In contrast a low speed printing process may be one in which print agent is applied on a portion of the substrate over a plurality of passes (which may be referred to as scanning).

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above -mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A print agent drying unit to dry print agent on a substrate, the drying unit comprising:
a substrate support to support a substrate;
an exciter to excite a boundary layer of print agent applied on the substrate, to thereby dissociate the boundary layer from the print agent;
a radiation source to direct radiation energy to the substrate to dry the print agent.

2. A print agent drying unit according to claim 1, wherein the exciter is separate from the substrate support, and wherein the exciter is to direct acoustic waves towards the substrate to dissociate the boundary layer from the print agent.

3. A print agent drying unit according to claim 2, comprising a controller to control the exciter to direct acoustic waves towards the substrate having a frequency within a frequency range of between 1 kHz and 200 kHz.

4. A print agent drying unit according to claim 2, comprising a controller to control the exciter to direct acoustic waves towards the substrate having an amplitude range of between 1 micron and 200 microns.

5. A print agent drying unit according to claim 1, wherein the radiation source is to radiate ultraviolet radiation.

6. A print agent drying unit to dry print agent on a substrate, the drying unit comprising:
a substrate support to support a substrate;
an exciter to cause the substrate to vibrate on the substrate support so as to excite a boundary layer of print agent applied on the substrate, to thereby dissociate the boundary layer from the print agent;
a heater to heat the print agent to dry the print agent.

7. A print agent drying unit according to claim 2, wherein the exciter is integral with or coupled to the substrate support to cause the substrate support to vibrate.

8. A print agent drying unit according to claim 6, wherein the exciter comprises a plurality of suction passageways for coupling to a vacuum source for retaining the substrate against the substrate support.

9. A print agent drying unit according to claim 6, wherein the exciter comprises a piezoelectric transducer or a moving coil transducer.

10. A print agent drying unit according to claim 6, comprising a controller to control the exciter to vibrate the substrate at a frequency within a frequency range of between 100 Hz and 100 MHz.

11. A print agent drying unit according to claim 6, comprising a controller to control the exciter to vibrate the substrate at an amplitude within an amplitude range of between 10 microns to 200 microns.

12. A method comprising:
applying a print agent to a substrate, the print agent comprising a first solvent, a second solvent and a functional solute, wherein the second solvent is to inhibit drying during application:
heating the print agent to dry the print agent, thereby causing partial vaporisation of the first solvent and the second solvent to generate a vapour-saturated boundary layer at a surface of the print agent;
causing excitation of the boundary layer, to thereby dissociate vapour of the second solvent at the vapour saturated boundary layer from the print agent.

13. A method according to claim 12, wherein the second solvent is non-volatile or slow-drying.

14. A method according to claim 12, comprising vibrating the substrate to cause the excitation of the boundary layer.

15. A method according to claim 12, comprising directing acoustic waves to the substrate to cause excitation of the boundary layer.
